(19) United States
(12) Patent Application Publication
(10) Pub. No.: US 2009/0301185 A1
(43) Pub. Date: Dec. 10, 2009

(54) Swimmer Flow Meter

(76) Inventor: Brian Thomas Duk, Mission Viejo, CA (US)

Correspondence Address: BLANCHARD & ASSOCIATES, 566 WEST ADAMS STREET, SUITE 600, CHICAGO, IL, 60661, US

(21) Appl. No.: 12/389,702

(22) Filed: Feb. 20, 2009

Related U.S. Application Data
(63) Continuation of application No. PCT/US2007/076397, filed on Aug. 21, 2007.
(60) Provisional application No. 60/839,021, filed on Aug. 21, 2006.

(51) Int. Cl. G01F 15/00; G01B 13/00

(52) U.S. Cl. 73/198; 73/861.77

(57) ABSTRACT

An apparatus and method for measuring distance traversed by a swimmer are provided. The apparatus comprises a casing with a flow-meter, a recording device, a transmitter and a receiving device to relay distance traversed by the swimmer.

### REFERENCE TO RELATED APPLICATIONS

This application is a continuation of PCT/US2007/076397 entitled “Swimmer Flow Meter” filed Aug. 21, 2007, which was published in English and claimed the benefit of U.S. Provisional Application No. 60/839,021 entitled “Swimmer Flow Meter” as filed on Aug. 21, 2006, each of which are incorporated herein by reference.

### BACKGROUND

Recreational swimmers and competitive athletes are interested in knowing their total distance traversed, average pace, and pace per interval, for both fitness and performance purposes. When in the water, it is often difficult for swimmers to keep track of the number of laps swum in a pool. Additionally, athletes swimming in open water have difficulty measuring distance crossed or performance other than using some object as a reference point and/or a watch. Rather than concentrate on the tedious task of counting laps, etc., many swimmers would rather focus on technique or let their minds roam and relax while swimming.

What is needed is an apparatus that measures the distance that a swimmer traverses in a pool or in open water. The apparatus should be able to accommodate all strokes and provide not only distance, but pace information as well and transmit that information to the swimmer while the swimmer is swimming. The apparatus should also be able to store this information such that the swimmer can gauge his performance, improvement, etc. In addition, there is needed an apparatus that may provide additional performance-related information, such as heart-rate, and blood oxygen levels. The present invention provides such an apparatus as well as methods of its use. These and other advantages of the invention, as well as additional inventive features, will be apparent from the description of the invention provided herein.

### SUMMARY

The invention provides an apparatus for measuring distance traversed by a swimmer. The apparatus comprises a device connected to the swimmer for detecting one or more characteristics of water flowing past the swimmer, a transmitter responsive to the device and also connected to the swimmer for generating electromagnetic signals that include information about the distance traveled by the swimmer, and a receiving device responsive to the electromagnetic signals. The distance traversed by the swimmer is determined by detecting the characteristics of water, and the distance traversed is transmitted to the receiving device.

The invention provides methods of use of the apparatus. In one embodiment, a method of measuring a distance traversed by a swimmer is provided. The method comprises detecting one or more characteristics of water flowing past the swimmer, generating information from the one or more characteristics about the distance traveled by the swimmer; and recording the distance traveled. The information is subsequently relayed to the swimmer while the swimmer is swimming.

The invention further provides a product for measuring a distance traversed by a swimmer. The product includes a package containing an apparatus for measuring a distance traversed by a swimmer, and instructions for use therein. The apparatus comprises (a) a device to detect one or more characteristics of water flowing past the swimmer, (b) a transmitter responsive to the device and that generates an electromagnetic signal, and (c) a receiving device responsive to the electromagnetic signal. The distance traversed is determined by detecting one or more characteristics of water, and the distance traversed is transmitted to the receiving device.

These and other advantages will become apparent from the description below.

### BRIEF DESCRIPTION OF THE DRAWINGS

FIG. 1 is a perspective view of the apparatus shown on the dorsal side of a swimmer in accordance with one embodiment of the invention;

FIG. 2 is a perspective view of the apparatus shown on the ventral side of a swimmer in accordance with another embodiment of the invention;

FIG. 3 is a perspective view of the apparatus in accordance with yet another embodiment of the invention;

FIG. 4 is a perspective view of the apparatus in accordance with yet another embodiment of the invention;

FIG. 5 is a perspective view of apparatus in accordance with another embodiment of the invention;

FIG. 6 is a schematic of the operating mechanism of the apparatus;

FIG. 7 is a perspective view showing the relationship between the cylinder, the sensor and the processor, according to one embodiment of the invention;

FIG. 8 is a plan view of the cylinder, according to one embodiment of the invention;

FIG. 9 is a plan view of the cylinder according to another embodiment of the invention; and

FIG. 10 is a perspective view showing the relationship between the cylinder, the sensor and the processor, according to another embodiment of the invention;

FIG. 11 is a perspective view of a diaphragm near the outlet of the flow-meter, according to one embodiment of the invention.

FIG. 12 is a block diagram of the processor according to one embodiment of the invention.

FIG. 13 is a perspective view depicting the one-way flow of water within the flow-meter, according to one embodiment of the invention.

### DETAILED DESCRIPTION

The invention provides an apparatus that measures the distance traversed in water by a swimmer. In one embodiment, the apparatus includes an outer casing, a device capable of detecting the flow rate of water, a transmitter, and a receiving device. The distance traversed by a swimmer is determined by detecting the flow of water and information about the distance traversed is subsequently transmitted to the receiving device. The apparatus is able to determine the distance traversed regardless of the stroke used by the swimmer. That is, the swimmer may swim free-style, butterfly, breast stroke, back stroke and side-stroke, combinations thereof, and the apparatus is able to detect the distance traversed.

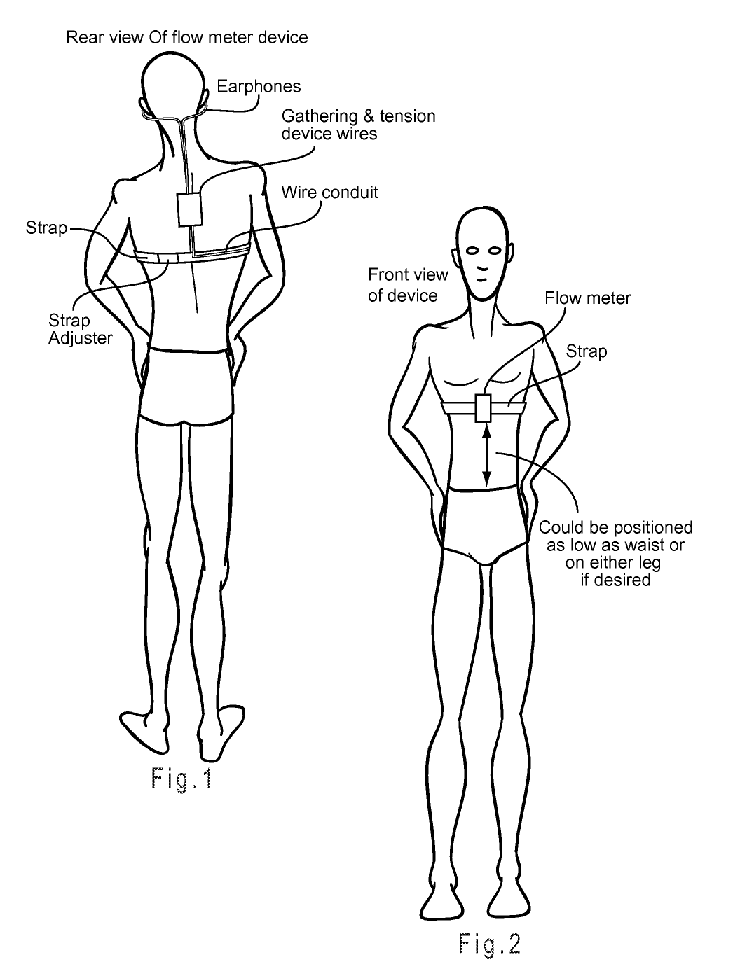

The apparatus has two parts. The first part is the measuring piece and is worn on the body of the swimmer. The second part contains the receiving device and is physically separate from the measuring piece. The measuring piece should be positioned and attached to the swimmer such that the flow of water can be detected. In this regard, the measuring piece should be placed on the swimmer in a location that is constantly submerged in water as opposed to a shoulder or arm that is only intermittently under water while swimming. In a preferred embodiment, the measuring piece may be fitted on to a belt or chest strap. The ventral side will contain the measuring piece and the dorsal side may hold wires to feed information to be transmitted to the receiving device (see FIGS. 1 and 2). Optionally, an additional adjustable strap may be added to the torso and utilized to minimize tangling of the wires. The length of wire that extends from the dorsal side of the strap to the receiving device should be adjustable. Optionally, a channel, loops with velcro, buttons, snaps, etc., may be in the strap to maintain wires in place. Optionally, a tension system, analogous to a reel on a tape measure, may be used so that once anchored to the receiving device, a comfortable tension is maintained (see FIG. 5). This will also minimize tangling as the wires are aligned along the center of the spine to the base of the skull before splitting to a receiving device located in an ear piece, goggles, etc. In an alternate embodiment, the receiving device contains a wireless receiver and there are no wires or cords connecting the measuring piece to the receiving device. In this embodiment, the information is transmitted wirelessly, via a wireless transmitter to the receiving device. Such technology is known to those in the art, such as that used in heart rate monitors made by POLAR and NIKE (e.g. Nike Model TRIAX CV10). All information contemplated to be transmitted by wire may be transmitted wirelessly by adding a small wireless transmitter to the sensing mechanism and the receiving device (i.e., a headset). The apparatus may be worn on the waist, chest or other location that is comfortable and conforms to the swimmer's unique body characteristics as well as the requirement that it be constantly submerged to accurately detect water flow and thus distance traversed.

The outer casing and receiving device of the apparatus may be made of any material suitable for repeated and prolonged immersion in water, that is, chemically treated water (i.e., a pool), fresh water, salt water, etc. The material should also be capable of producing a water tight seal (either alone or in conjunction with gaskets, etc.) such that certain inner workings of the apparatus are maintained in a dry environment. Non-limiting examples of suitable casing materials include plastic, metal, rubber and combinations thereof. The material should be durable, strong, light weight and relatively inexpensive to use. Examples of suitable plastic include injection molded or blow molded PVC, ABS, polycarbonate plastic, and combinations thereof. Suitable metals include stainless steel, such as type 303 or 304. Examples of suitable rubber include, but are not limited to, neoprene, nitrile, butadiene rubber, and combinations thereof. For example, neoprene gaskets may be used to prevent water seepage. These and other materials are well known to those in the art.

The casing may be any color or shape suitable for use with the present invention. For instance, the casing may be colored, patterned, or personalized. Such personalization may include name, pictures, owner information, manufacturer name and/or logo, team/school mascots or names, etc. The casing may be a rectangle, triangle, square, pentagon, circle, oval, or any other shape. The size of the apparatus and hence the casing, is preferably about 1 inch to about 4 inches long, and about 0.5 inch to about 1 inch wide and deep.

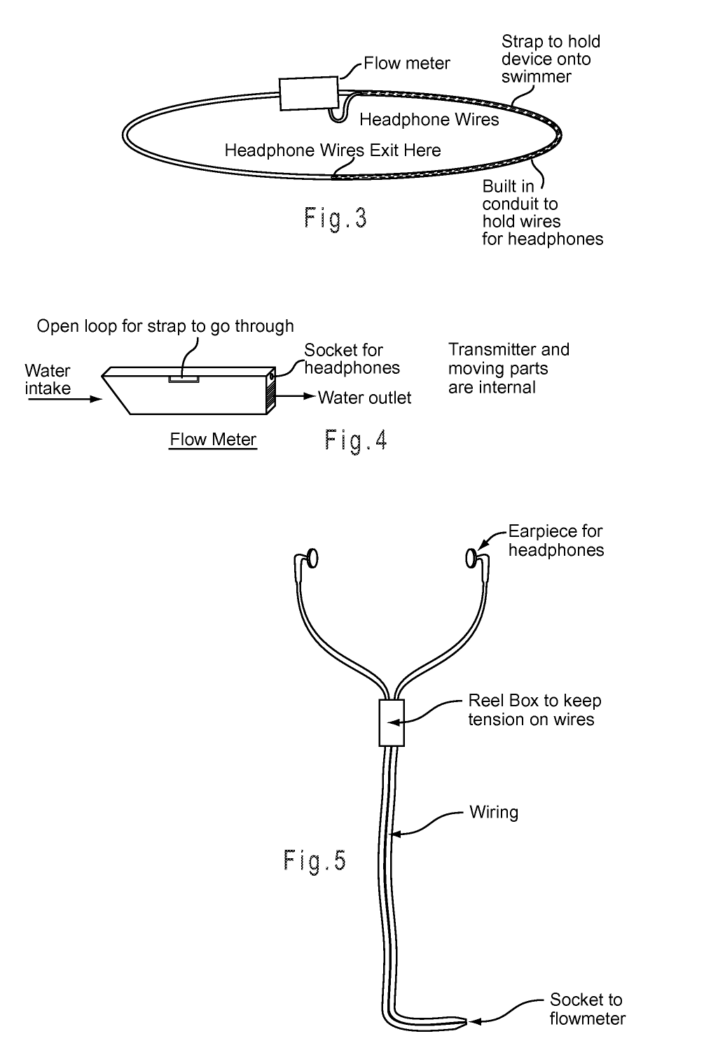

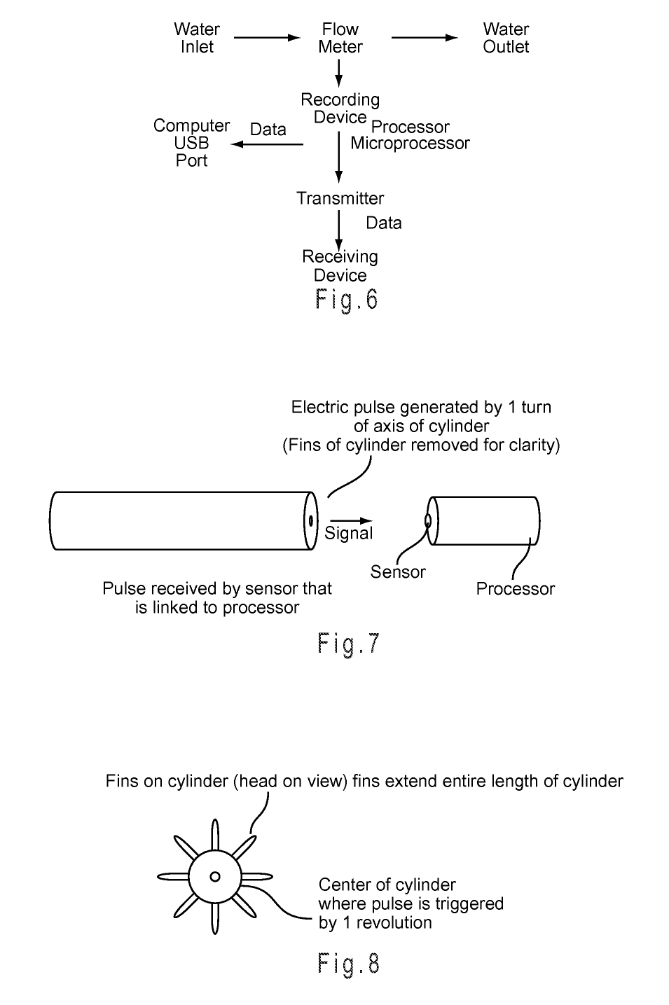

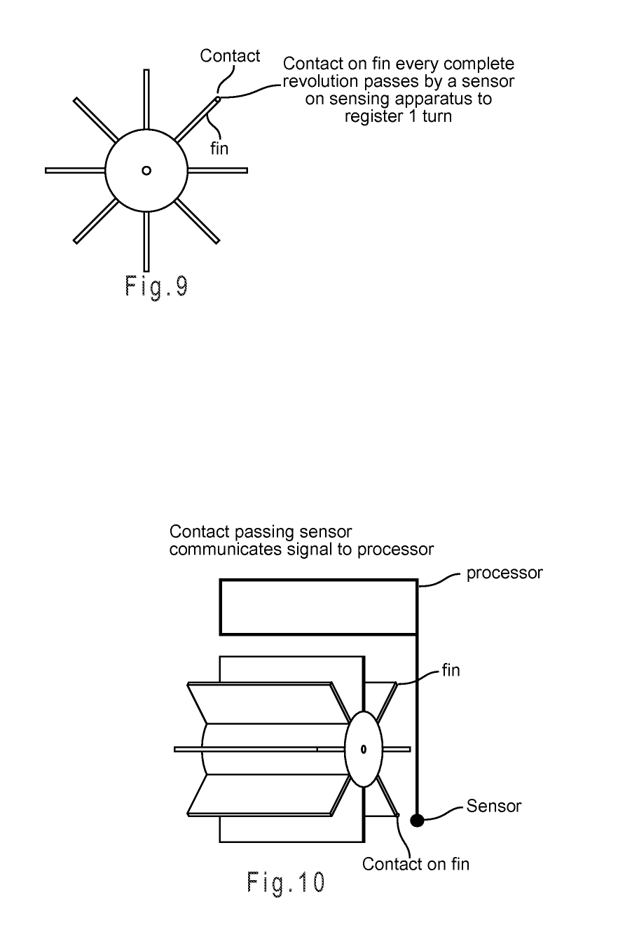

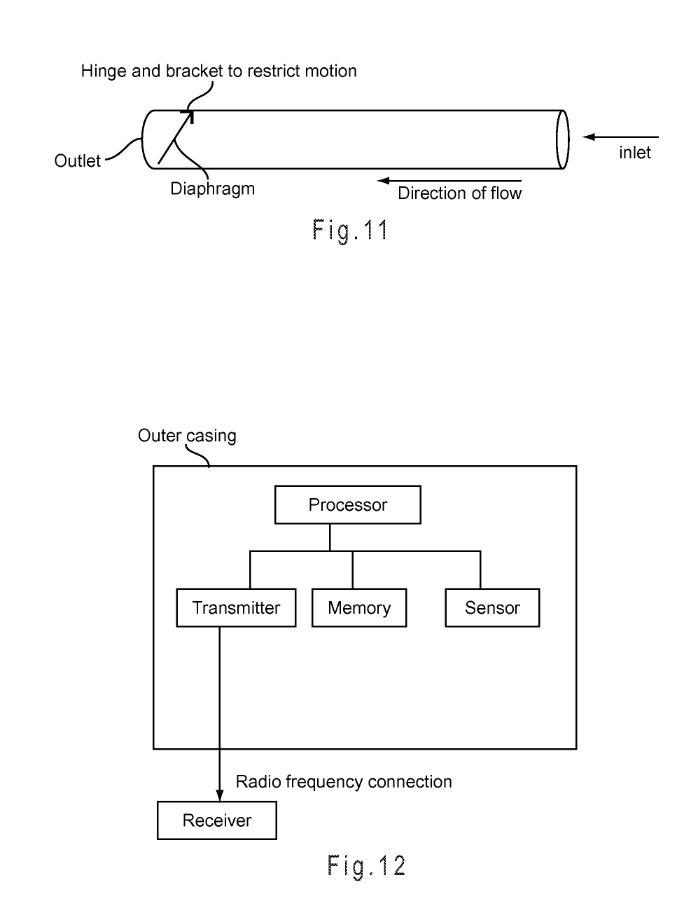

The device for detecting one or more characteristics of water flowing past the swimmer, such as the flow of water, may be a flow-meter (see FIGS. 3 and 4). The flow-meter, in certain embodiments, includes a rotating portion, such as a cylinder, that rotates in response to water flowing through the apparatus and a processor. In one embodiment, the rotating portion of the flow-meter may resemble a turn-style. In a preferred embodiment, the rotating portion of the flow-meter is cylindrically shaped with fins (see FIGS. 7-9). Preferably, the fins are square shaped. The fins should be of sufficient number and size to allow for consistent rotation when presented with a viscous fluid through the opening facing the direction of motion. The flow of water over or around the detecting device should be laminar and such that any turbulence within the apparatus is minimized or eliminated. In that regard, in an embodiment in which a turn-style type of detecting device is used, the device may take on an “S” shape (see FIG. 13). The water enters the device from the direction that the swimmer is swimming and proceeds to follow the path of the channel provided for it, which begins with a gentle slope, becomes more steep until it is approximately 30 degrees from perpendicular to the swimmers body, at which point is make contact with the turnstyle mechanism and begins to turn the fins which then indicate distance and pace via the aforementioned described herein. Finally, the path followed by the water gradually levels off until in is approximately 10 degrees less than parallel with the swimmer's body, at which time the water exits the apparatus. This design will serve to minimize the turbulence and backflow, as water entering the device from the direction opposite to that in which the swimmer is swimming would be forced to travel “up hill” in order to cause turbulence via backflow. Given the direction of motion of the swimmer, the shape of the channel through which the water proceeds, and the ability to calibrate the device, turbulence and backflow would have a minimal effect on accuracy. The turning of the cylinder to which the fins are attached is detected by a sensor or contact, and is recorded by a device that measures each revolution. In a preferred embodiment, water flows into the apparatus through an inlet. The water contacts the flow-meter and the rotating portion rotates in response to the water flowing through. The water exits through an outlet in the apparatus. The one-way flow of water may be maintained by numerous mechanisms, non-limiting examples of which are set forth herein. For instance, a one-way valve, sometimes referred to as a purge valve on devices such as a snorkel (see AERIS Barrracuda dry flex snorkel) or a purge mask (see H2O Alpha 2 purge mask), may be positioned just prior to the outlet and oriented in the appropriate direction so that water may proceed in the opposite direction that the swimmer is swimming, but backflow is prevented. Another exemplary mechanism is a hinged diaphragm, which would allow the flow of water in the opposite direction that the swimmer is swimming through the inlet, but would prevent backflow. The hinge and bracket of the diaphragm should allow a sufficient degree of motion of the diaphragm such that the diaphragm maintains enough surface area available in the backflow direction such that any backflow will cause the diaphragm to close the outlet (see FIG. 11). In this way, backflow will not occur. The degree of motion maintains an aspect of the diaphragm available to the backflow, and thus would be closed should backflow become significant. In yet another example, a spring tension pawl mechanism, such as that found on a ratchet wrench may be utilized, which allows motion, and hence flow of water, in only one direction. In one embodiment, the shape of the fins (see FIGS. 8-9) and inlet are such that the rotating portion of the flow-meter is capable of rotating in only one direction as well. In this regard, the water is flowing through the apparatus in the opposite direction that the swimmer is moving. In reality, the issue of backflow should be minimal, as the rotation of the rotating portion of the flow-meter will be substantially driven in one direction given the direction of the swimmer's motion. Even minimal velocity will provide substantial flow of water, creating momentum in one direction that would be difficult to overcome with backflow of sufficient force to reverse the direction of the rotating portion of the flow-meter.

In another embodiment, the distance traversed for use in a pool or area of defined distance in which repetitive lengths will be swum may also be determined by a small weighted sensor suspended from an axel such that it is perpendicular to the axel on one end, and the ground beneath the swimmer on the other end. The weight may be suspended by wire, solid metal, plastic, or other substance. The point of suspension should be either tied, or hooked to a hole in the axel, so that it is firmly attached to the axel. The suspended sensor will freely move in the opposite direction of the swimmer in response to the swimmers forward motion. When the swimmer's motion is stopped, or slowed down as the swimmer reaches the wall (of a pool, for example), the momentum of the sensor will take it beyond perpendicular to the ground in the direction the swimmer was moving before stopping. When the sensor passes beyond perpendicular by more than about 5 degrees in the direction the swimmer was swimming before stopping, or flipping over at the wall, the detector, placed under the suspended sensor, will detect that specific motion, in that direction, and indicate a single turn. The detector will be programmed to emit a single signal indicating a unit length has been completed about a maximum of one time per twenty second interval. The signal will be transmitted to the central processing unit and correlated with a value entered by the swimmer indicating the length of one unit, and the aggregate length swum. The swimmer will then use the watch containing the mechanism that computes distance to ascertain distance traversed and lengths swum, which will be available menu display options. Alternatively this information would be available in the same manner as all of the other information, on the goggles, watch, etc.

An alternate method of detecting a distance traversed or a single length swum relates to the method of detecting distance swum by recording pressure changes using a pressure sensor. One length swum would be indicated by a pressure decrease of more than about 20 percent, lasting more than about one second. Any such change in pressure detected by the detector will be transmitted to the central processing unit which will be programmed to interpret such a decrease in pressure as a single unit swum. The units (lengths) would be correlated to a known distance per length programmed by the swimmer on the watch. This information would be available to the swimmer in the same manner as all of the other available information

Another alternative relates to the previously described rotating wheel, sensor and detector that correlate revolutions to distance swum via calibration. When the detector detects a decrease in revolutions of more than about 20 percent, lasting more than about 1 second, it sends a signal to the central processing unit indicating 1 unit length has been completed. As above, the unit is correlated to a value entered by the swimmer as the known distance per length. This information would be available to the swimmer in the same manner as all other information available as the result of the processing unit.

A stored-program computer is utilized for obtaining and storing information in accordance with the present invention, and is designed according to von Neumann architecture principles. An example of which is shown in FIG. 12.

The processor of the flow-meter is operable to store the data, that is the total number of revolutions as well as the number of revolutions in a given period of time that are made by the rotating portion of the flow-meter (see FIGS. 7-10). To initialize the apparatus, a number of test runs may be made in order to correlate the number of revolutions of the flow-meter with the know distance swum. Then, an algorithm that is programmed in the processor may be used to determine the distance traversed in water per number of revolutions. A program can be written to modify the algorithm on a semi-permanent basis that can be stored. The program can contain multiple algorithms, therefore, one swimmer may have more than one setting to accommodate one swimmer or multiple swimmers, as well as programs saved for different types of swim strokes, types of water (i.e. a pool, lake, or saline environment such as an ocean) programs for one swimmer or multiple swimmers. That is, a different algorithm may be stored for a swimmer to suit different workouts or different locations of his swim. For instance, a different program may be set for swims in a pool versus swims in a lake. For swims in water with a current, the baseline movement of the rotating device when the swimmer is at rest may be taken into account by the swimmer positioning his body temporarily in a floating position. Alternatively, the swimmer could swim a known distance, and calibrate the device accordingly, thus taking into consideration the passive movement of water experienced by the swimmer at rest. This calibration would further serve to accurately tune the device to the specific stroke technique of the swimmer. For instance, a first swimmer may have different program for backstroke and breast stroke in both pool water as well as open water. Thus saving, for example, four programs for one swimmer. In addition, the program can be recalibrated for the same swimmer whose stroke has changed over time. The technology required for such programs is known in the art. For example, the programs used in the NIKE SD devices, such as the Triax CV 10 and Triax Elite watches, can be adapted for use in the invention.

In one embodiment, a calibration device may be used to calibrate the flow-meter when necessary. The calibration device may be in the form of a wristband, watch, or device fitted to goggles. The calibration device should contain a digital reading of the information that is also relayed to the swimmer's receiving device. The distance traveled after a certain known distance, such as 100 meters can then be measured against what the calibration device reports. The calibration device may then be calibrated to the true distance by manipulation of buttons thereon. This is important as the incorporation of flip turns, a swimmer's unique style, or the current in which he is swimming may impact the accuracy of the apparatus. A simple calibration will make the apparatus highly accurate. An example of suitable calibration technology may be found in NIKE Triax CV10 and Triax Elite watches. However, for the purpose of the invention, the calibration device must have buttons that may be depressed while immersed in water. As such, one or more gaskets such as those found on diving watches should be utilized to prevent damage to internal components. These types of gaskets are well known in the art. Obviously, numerous variations of saved programs are possible for one or more swimmers and all variations are contemplated within the scope of the invention.

In a preferred embodiment, the apparatus includes a recording device. The recording device is capable of keeping track of the number of revolutions made by the rotating portion of the flow-meter. The recording device and flow-meter communicate in some regard. The flow-meter has a reporting mechanism. The reporting mechanism may be a flange (i.e., a contact on a fin, see FIGS. 9-10) within the rotating portion that extends such that when a revolution takes place, the flange comes into contact with a fixed mark on the recording device and signals the recording device to count “1” turn. The number of turns is then used to determine the distance traversed. In an alternate embodiment, the reporting mechanism may be a pressure sensor that is used to determine the flow of water through the apparatus, and is subsequently recorded by the recording device. Once recorded, the data is processed by a microprocessor operable to translate it into a language (visual or oral). The microprocessor can be any known microprocessor and can be programmed in any known manner, including higher level languages, such as a C, C++, Pascal and the like, or lower level assembly or microprocessor-specific instruction sets. Any language may be programmed into the apparatus such that the apparatus may be used world-wide. Examples of languages that may be programmed include, but are not limited to English, Spanish, French, Portuguese, German, etc. The information is relayed from the recording device, via the transmitter, to the receiving device at intervals chosen by the swimmer.

A transmitter responsive to the detecting device is also connected to the swimmer. The transmitter of the invention transmits, among other things, the information that is recorded about the number of revolutions of the rotating portion of the flow-meter. The transmitter generates signals in order to transmit the information to a receiving device. Additional information that may be transmitted to the receiver includes heart rate, overall pace, pace per interval, blood oxygen level, a pacing signal, music, and combinations thereof. In one embodiment, the transmitter transmits the information via radio frequency to the receiving device. Radio frequency technology is known to those of skill in the art and can be readily adapted to work with the inventive device.

The receiving device is responsive to the signals generated by the transmitter about the distance traversed such that it may then be relayed to the swimmer. The receiving device may be placed anywhere on the swimmer such that it may relay information from the transmitter. In that regard, the receiving device may be on or in an earpiece, goggles, a swim cap, an earphone head set, including those that operate by vibration traveling through bone (such as the jaw bone), and combinations thereof. The receiving device should be water proof. Water proof ear pieces and headsets are known to those in the art. The earphone head set of the SwiMP3, which uses bone conduction to convey sound underwater, is an example of a water proof technology that may be used in the invention in order to relay information to the swimmer.

The information received and relayed to the swimmer may be auditory, visual, or both. For instance, a number, a flash of light, a beeping or ringing tone, or voice (machine or human), and combinations thereof, indicating the number of laps, distance, overall pace, pace per interval, heart rate, blood oxygen levels, a pacing signal, and combinations thereof may been relayed to the swimmer visually, or in an auditory manner. In a preferred embodiment, the swimmer is able to program the apparatus to relay the information of interest to the swimmer. Therefore, the apparatus is customized to the individual needs of the swimmer. For instance, the number of laps could be indicated visually by a number displayed on the swimmers goggles, or in an auditory manner such that the number is “spoken” in the swimmer's ear via an earpiece. The distance, overall pace, pace per interval, heart-rate and blood oxygen levels may be relayed in the same manner. In a preferred embodiment, the number of meters, feet, miles, and combinations thereof may be displayed or spoken to the swimmer. A pacing signal may be transmitted in the manner preferred by the swimmer. The pacing signal may be visual, such as a flashing light or a letter or a word, or auditory, such as a word, a beep, a ring, etc. The pacing signal may provide a cadence so that the swimmer may maintain a certain pace. In that regard, the visual signal that indicates a tempo or that tells the swimmer when to take a stroke with a given arm or to kick. For example, an “L”, or “left” could be displayed on the swimmer's goggles each time the swimmer should take a stroke with his left arm and “k” or “right” could be displayed to indicate a stroke with the right arm is required. Further, “L” or “left” and “R” or “right” could be alternately displayed. In another embodiment, a flash of light could indicate the same. Alternatively, a beep, a word such as “left” or “right” may indicate the same action is required by the swimmer in order to maintain a certain pace. Another alternative would allow a single beep for every other stroke or every stroke, or every stroke by the right or left arm. The apparatus may be further customized by the swimmer to maintain a constant signal or display or to report at certain intervals. The apparatus may be programmed to relay certain information in a visual manner and other information in an auditory manner, to suit the swimmer. For example, the swimmer may prefer to have distance displayed visually, but have the cadence relayed in his ear. There are numerous potential variations for relaying the information to the swimmer. All potential combinations are contemplated by the present invention. The information is recorded and reported in the swimmer's native or preferred language, at intervals specified by the swimmer as dictated by a program that allows for such choices and is written to respond to various combinations of buttons pushed on the measuring piece.

The technology for relaying the information to the swimmer is known to those in the art. Examples include that used in the SwiMP3, and in watches designed to assist the visually impaired, such as the talking atomic clock (REIZEN), Tel Time (QUARTZ) and the Royal line of talking watches. Further the gasket system used in the SwiMP3 can be adapted to ensure that the receiving device is water proof. This same gasket technology may also be used in the measuring piece of the apparatus to maintain a water proof state of the inner workings despite the fact that exterior buttons may be pressed in order to activate and use the measuring piece.

The number of revolutions of the rotating portion of the flow-meter is correlated with the distance traversed using an algorithm. A suitable algorithm will relate the number of rotations to distance. The algorithm is created by first using the apparatus and swimming a known distance such that the numbers of revolutions of the revolving device are equated with a known distance (i.e., distance equals number of turns/time). Subsequent distances traversed are then determined based on the number of revolutions. Suitable algorithms can take into account the number of revolutions in a given time to compute distance, as opposed to merely the total number of revolutions. For example, 100 revolutions in 10 minutes equates to a longer distance than 100 revolutions in 30 minutes, despite the equivalence in the number of revolutions. Those of skill in the art will appreciate that there are various ways to configure the algorithm for use with the invention. All algorithms suitable for determining distance traversed are contemplated by the present invention.

The apparatus of the invention includes a means for supplying power to the apparatus. For instance, a battery may be used. In a preferred embodiment, the battery is housed in a compartment of the apparatus with 1 or more layers of gaskets to shield it from water. Preferably, at least 2 gaskets are used. In an alternate embodiment, the apparatus is fitted with a small mechanism harness the motion of the turnstile into electricity that may be used to power the device itself when in motion and to store enough power such that various selections may be made in terms of preferences/customization before the swimmer begins to swim and generate power. A combination of battery and generator mechanism may be used to preserve battery life, charge a re-chargeable battery, in addition to or in lieu of a conventional battery.

The strap to which the measuring piece of the apparatus is attached may be similar to that of the NIKE chest strap that accompanies the Triax CV 10 or the Triax Elite watches. Further, the strap may include heart rate monitor sensors such as those found on NIKE or POLAR equipment. The apparatus may further play music in a manner similar to that of the SwiMP3. The strap may also contain blood oxygen sensors that use light to monitor capillary color, similar to that used in hospital settings, so long as it is placed against the swimmer's bare skin in an area without excess fat layers. The strap may be placed on the swimmer's bare skin, or over a bathing suit or swim trunks. Preferably, the strap is placed around the chest, or waist.

The invention also provides a way to track progress over time. The apparatus is compatible with various computer operating systems, examples of which include WINDOWS, MAC OS 9 & 10. The invention may include USB port hook-up to allow swim data to be saved and tracked over time. This will allow the swimmer to monitor progress for a given stroke, in a given type of water. Further, the apparatus may be loaded with digital music, books or other forms entertainment using technology found in items such as found in the SwiMP3, MP3 players, and iPods.

The invention provides methods of use of the apparatus. The method includes affixing an apparatus to a swimmer that includes a casing, a device to detect the flow of water, a recording device, a transmitting device, and a receiving device. The distance traversed is determined by detecting the flow of water. The information is recorded and transmitted to a receiving device. The information is subsequently relayed to the swimmer while the swimmer is swimming.

In another embodiment, the invention provides a product. The product includes a package and an apparatus for measuring distance traversed by a swimmer therein, and instructions for use of the apparatus.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An apparatus for measuring distance traversed by a swimmer comprising:
a device connected to the swimmer for detecting one or more characteristics of water flowing past the swimmer,
a transmitter responsive to the device and also connected to the swimmer for generating electromagnetic signals that include information about the distance traveled by the swimmer, and
a receiving device responsive to the electromagnetic signals.
wherein said distance traversed by said swimmer is determined by detecting said characteristics of water, and said distance traversed is transmitted to said receiving device.

2. The apparatus of claim 1, wherein said device to detect said characteristics of water is a flow-meter.

3. The apparatus of claim 1, wherein said flow-meter rotates as water flows through said apparatus.

4. The apparatus of claims 1, wherein said apparatus further comprises an inlet and an outlet for said water.

5. The apparatus of claim 1, wherein said apparatus further comprises a recording device.

6. The apparatus of claim 5, wherein said recording device records a number of revolutions of said flow-meter.

7. The apparatus of claim 1, wherein said receiving device is selected from the group consisting of an earpiece, goggles, a swim cap, and combinations thereof.

8. The apparatus of claim 3, wherein a number of revolutions of said flow-meter is converted to said distance traversed by said swimmer.

9. A method of measuring a distance traversed by a swimmer, the method comprising:
detecting one or more characteristics of water flowing past the swimmer,
generating information from the one or more characteristics about the distance traveled by the swimmer; and
recording the distance traveled.

10. The method of claim 9, wherein said distance traversed is determined utilizing the apparatus of claim 1.

11. The method of claim 10, wherein said receiving device relays said distance traversed to said swimmer.

12. The method of claim 11, wherein said receiving device relays said distance traversed to said swimmer in a manner selected from the group consisting of an auditory signal, a visual signal, and combinations thereof.

13. The method of claim 10, wherein said apparatus further comprises means to transmit additional information to the swimmer selected from the group consisting of heart rate, pace, pace per interval, blood oxygen level, a pacing signal, music, and combinations thereof.

14. The method of claim 13, wherein said additional information is transmitted to said swimmer in a manner selected from the group consisting of an auditory signal, a visual signal, and combinations thereof.

15. A product for measuring a distance traversed by a swimmer comprising:
a package containing an apparatus for measuring a distance traversed by a swimmer, and instructions for use therein, wherein said apparatus comprises (a) a device to detect one or more characteristics of water flowing past the swimmer, (b) a transmitter responsive to the device and that generates an electromagnetic signal, and (c) a receiving device responsive to the electromagnetic signal,
wherein said distance traversed is determined by detecting one or more characteristics of water, and said distance traversed is transmitted to said receiving device.
